(19) United States
(12) Patent Application Publication
(10) Pub. No.: US 2014/0358986 A1
(43) Pub. Date: Dec. 4, 2014

(54) Cloud Database-Based Interactive Control System, Method and Accessory Devices

(71) Applicant: Jijesoft Co., Ltd., Suzhou (CN)

(72) Inventors: Zuojun Min, Suzhou (CN); Chenyang Sun, Suzhou (CN)

(73) Assignee: Jijesoft Co., Ltd., Suzhou (CN)

(21) Appl. No.: 14/264,271

(22) Filed: Apr. 29, 2014

(30) Foreign Application Priority Data
May 30, 2013 (CN) 201310205924.0

(51) Int. Cl. H04L 29/08; A63H 30/04; H04W 8/08

(52) U.S. Cl. CPC H04L 67/141; H04W 8/08; A63H 30/04
USPC 709/202; 446/454

(57) ABSTRACT

An interactive control system and method, comprising providing a client program on a handheld or portable electronic device employing a wireless mode to obtain data from a cloud server, establishing a wireless data connection between the handheld or portable electronic device and an accessory device, using the wireless connection to establish direct communication between the handheld or portable electronic device and the accessory device, and then using the wireless connection for the handheld or portable electronic device to then transfer data previously obtained from the cloud server to the accessory device.

### CROSS-REFERENCE TO RELATED APPLICATION

This application claims priority of Chinese Patent Application Number 201310205924.0 filed on May 30, 2013, the entire disclosure of which is incorporated herein by reference.

### FIELD

This invention involves an interactive control system and method, namely one that is cloud database-based, and accessory devices.

### BACKGROUND

Devices such as intelligent toys (e.g., stuffed animals that can generate sounds and potentially movements) with embedded chips that are currently on the market are limited to certain functions using data previously loaded on the chip. These functions include recording sounds, executing a few simple actions, and producing some simple sounds. Moreover, these devices do not have requirements for functions like data extension, persona establishment, or background management, nor do they have requirements for aspects like background control. At the same time, only a few programs for handheld or portable electronic devices currently on the market possess the functionality for simple, one-way data transfers with accessory devices.

### SUMMARY

A purpose of this invention is to provide a cloud database-based interactive control method and accessory devices to solve the above problems that exist in the current technology. This purpose is achieved in part through the following.

A cloud database-based interactive control system and method wherein, using a client program, a handheld or portable electronic device (such as a tablet or smartphone) employs a wireless mode to obtain data from a database on a cloud server. A connection is established between the handheld or portable electronic device and an accessory device (such as an intelligent toy with embedded electronics and the like, as further explained below), and after the accessory device sends a conned command, the client program gives a receive command. The handheld or portable electronic device then transfers data previously obtained from the cloud server to the accessory device, based on user needs. Alternatively, after a launch command is issued by the client program on the handheld or portable electronic device, the accessory device issues a receive command; once data has been transferred to the accessory device, instructions can be sent from the client program for the accessory device to carry out corresponding operations.
In the above cloud database-based interactive control system and method, the connection method is preferably near-field communications, including sound waves or Bluetooth.
In the above cloud database-based interactive control system and method, the aforementioned actions come from a database. The database will determine, beforehand, a template for content suitable for exchange between the accessory device and the user, or between one accessory device and another. This template is added to or modified through the cloud server and pushed to the client software on the handheld or portable equipment, with the client software updating the data before it is downloaded to the accessory device.
In the above cloud database-based interactive control system and method, the corresponding operations include but are not limited to sounds (e.g., speech/dialogue), movements (e.g., gestures and/or actions), and media playback.

Cloud database-based interactive control accessory devices, which include a device body with embedded chip. This chip connects, respectively, with the device's user input devices, displays, network/bus interfaces, power supply units, solid state memory, RAM, and speakers.
The user input for these accessory devices includes one or more of buttons, keyboards, or a wheel.
A CODEC is between the speaker and embedded chip in these accessory devices.
The power supply units for these accessory devices include a battery that connects with the embedded chip through a charging module.
The display screen for these accessory devices is an LED or LCD.

Advantages of this invention include that the invention can support interaction, including dialogues, gestures, and actions, between the user and one or more accessory devices, or between two or more accessory devices. At the same time, the invention incorporates data extension, persona establishment, and background management as well as background control extension functions that can be effectively applied in various kinds of accessory devices such as intelligent toys.

### BRIEF DESCRIPTION OF THE DRAWINGS

The purpose, advantages, and features of this invention will be illustrated and explained through the following, selected examples. These are only typical examples that apply the technical proposals for this invention, and any technical proposals that employ equivalent substitutions or changes are within the scope of protection required for this invention. The attached figures include:

FIG. 1 schematically depicts the interaction between the cloud server and handheld or portable devices, and between handheld or portable devices and remote accessory devices of the interactive environment.

FIG. 2, a schematic of the communication flow in the overall system.

FIG. 3, a flowchart of local device service discovery on a personal area network (PAN).

FIG. 4, a flowchart of remote device service discovery on a PAN.

FIG. 5, a flowchart of data transfer between a cloud server and a local device on the Internet.

FIG. 6, a flowchart of a remote device downloading a database from a local device on a PAN.

FIG. 7, a flowchart of data requests between a handheld or portable electronic device and an accessory device on a PAN.

FIG. 8, a structural diagram of an exemplary accessory device.

### DETAILED DESCRIPTION

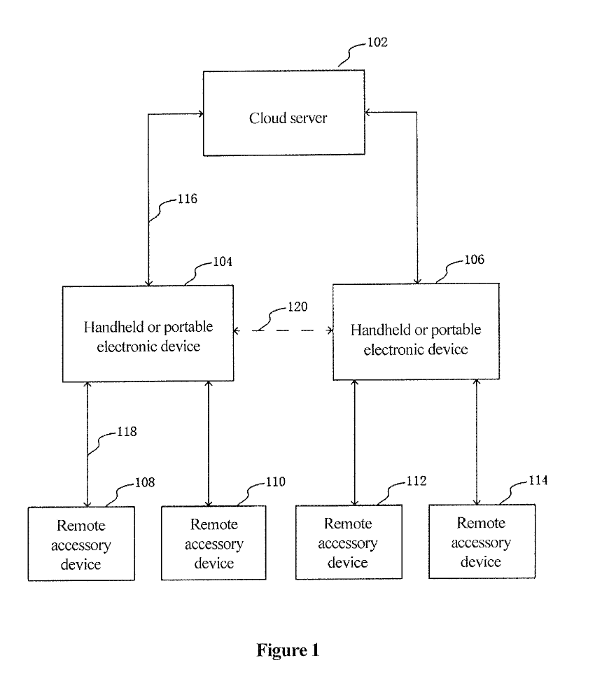

The cloud database-based interactive control system and method shown in FIGS. 1 to 7 includes the following: using a client program, a handheld or portable electronic device (sometimes called a “local device”) employs a wireless mode to obtain data from a database on a cloud server (sometimes called a “remote device”). A connection is established between the handheld or portable electronic device and an accessory device, and after the accessory device sends a connect command, the client program gives a receive command and the handheld or portable electronic device transfers data previously obtained from the cloud server to the accessory device based on user needs. Alternatively, after a launch command is issued by the client program on the handheld or portable electronic device, the accessory device issues a receive command; once data has been transferred to the accessory device, instructions can be sent from the client program for the accessory device to carry out corresponding operations.

One aspect of this invention is the use of near-field communications, including sound waves or Bluetooth, to achieve stable data transmission between the handheld or portable (local) electronic device and one or more accessory devices. Moreover, considering the abundance of actions that can be performed, the actions taken herein derive from a database which establishes a template, beforehand, for the content of exchanges between accessory device and user, or between accessory devices. The database is updatable, meaning that it can be added to and modified through the cloud server and then pushed to client software on handheld or portable devices; after the dent software is updated, the data is downloaded again to accessory devices. This process can be repeated according to user needs.

In addition, the invention's applicability is improved by providing for corresponding operations by the accessory device that include but are not limited to dialogues, gestures, actions, and media playback. This enables the invention to be widely used with all sorts of interactive toys.

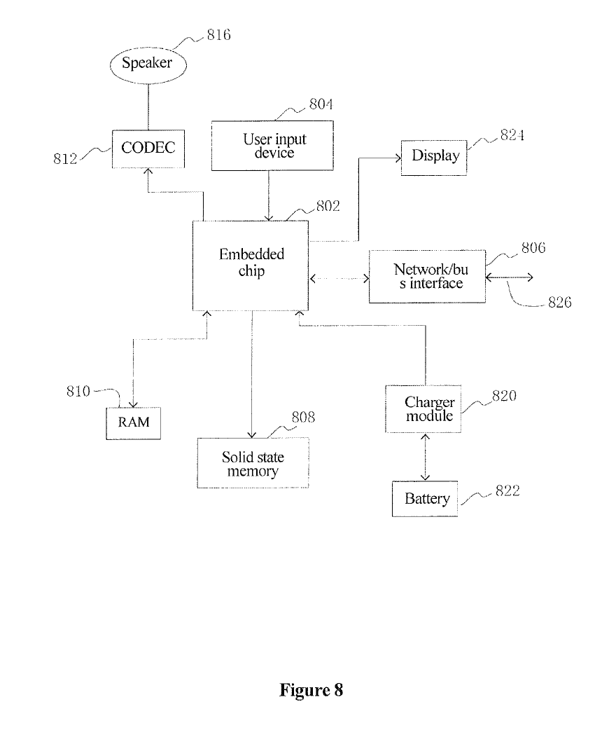

As for the system and methods used in realizing this invention, as shown in FIG. 8 it provides for an accessory device 800 that is controlled using a cloud database-based interactive control method. These accessory devices are characterized by a device body with embedded chip. The embedded chip (802) connects, respectively, with user input devices (804), displays (824), network/bus interfaces (806), power supply units, solid state memory (808), RAM (810), and speakers (816). The network/bus interface can be coupled to a data link (826).

In terms of specifics, for user convenience the user input device may be a button, keyboard, or wheel, or another known type of input device. This can be changed based on actual function, and to make it suitable for users of different ages.

In addition, a CODEC (812) is between the speaker and embedded chip, to produce an analog output signal for the speaker so that it can play back different sound sources. The power supply unit also includes a battery (822) connected to the embedded chip through a charging module (820), in view of the long operating periods for accessory devices. Thus, the accessory device can operate for a relatively long time on battery power, or as a result of charging the battery through the charging module.

Furthermore, in view of the different usage environments, and to provide for better display and keep users informed of device status, the accessory device display (824) is either an LED or LCD.

In terms of integrating this invention into actual use, it first provides an interactive environment, as shown in FIG. 1, that includes a cloud server (102) used for storing large amounts of data and managing the overall system. In addition, the interactive environment includes handheld or portable electronic devices (104 and 106), which are independent computing devices that can carry out various operations. Furthermore, handheld or portable electronic device 104 can be connected to accessory devices (108 and 110), and handheld or portable electronic device 106 can be connected to other accessory devices (112 and 114). These accessory devices are used for expanding the capabilities of the handheld or portable electronic devices, and interactive content from particular application programs on the handheld or portable electronic devices—including sounds, music, and actions—can be played or displayed on the accessory devices. Accessory device 108 is controlled by handheld or portable electronic device 104, connecting to it through a PAN (118). A handheld or portable electronic device can control multiple accessory devices. Handheld or portable electronic device 104 can be connected with handheld or portable electronic device 106 using a wireless network (120) or other methods, and thus accessory devices 108 and 110 or accessory devices 112 and 114 can interact via their controlling handheld or portable electronic devices.

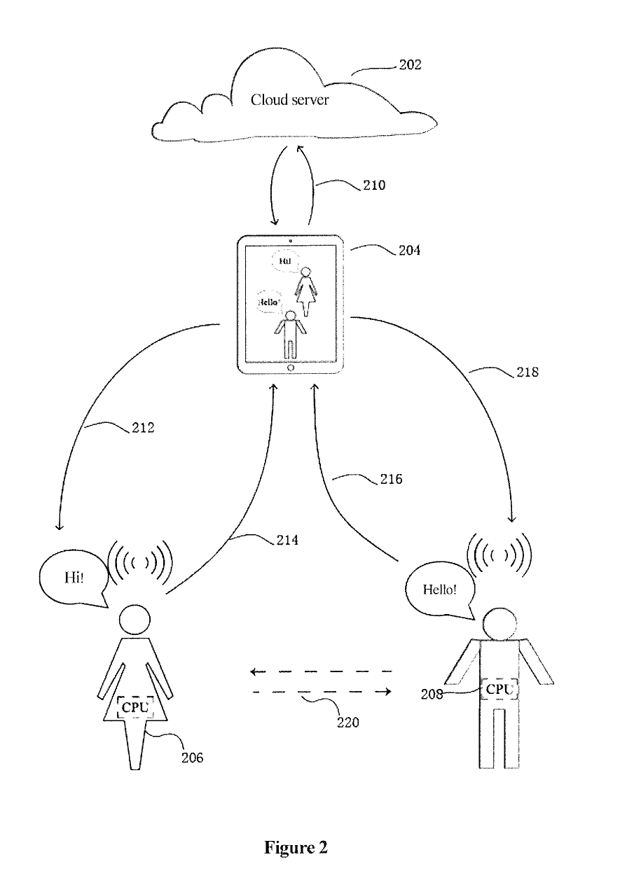

As shown in FIG. 2, the cloud server (202) connects with a handheld or portable electronic device (204) to exchange data files through the Internet (210). Commands (212) to the accessory device (206) (e.g., to generate a “hi” sound) are given via a handheld or portable electronic device (204); after receiving a feedback signal (214) that accessory device 206 has finished executing a command, handheld or portable electronic device 204 gives accessory device 208 the next command (e.g., to generate a “hello” sound) to execute (218). This creates what appears to be a spoken interaction between devices (e.g., intelligent dolls) 206 and 208. After finishing the command, accessory device 208 signals (216) to handheld or portable electronic device 204 that it has finished executing the command. Thus far, one interaction (220) has been completed between accessory devices 206 and 208; this process can be repeated many times, according to the contents of the database files on handheld or portable electronic device 204, to meet the need for interaction between accessory devices when interaction is used. As stated above the actions can include sound (such as speech) and actions (such as gestures such as head or arm movements). A result is that the two devices appear to the user, or to others present, to be interacting.

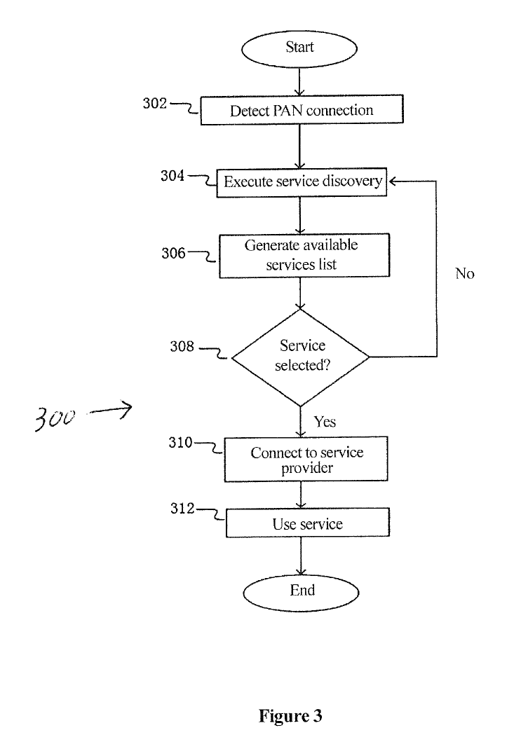

Referring to FIG. 3, a PAN generally only covers a few meters of physical space, and can be wired or wireless. For example, a wired PAN could employ Universal Serial Bus (USB) or IEEE 1394 connections, and a wireless PAN connection could use Infrared Data Association (IrDA), Bluetooth, ultra-wideband (UWB), or sound waves. Devices (one or more) operated as per connection service 300, FIG. 3, can be configured as any type of electronic device communicating through a PAN. A local device can detect (302) a PAN connection, and can have its transceiver configured to send and receive signals according to the protocol used for the PAN. The example is based on using the necessary public protocols, standards, and/or formats. PANs can support Bluetooth-compliant communications. At this point in the process, service discovery (304) is executed through devices on the PAN broadcasting the services they provide, and as a result of broadcasting these services and receiving similar broadcasts from other devices, the devices in the PAN can assemble (306) a list of services available in the network. Each device can generate its own list of the services that are available from remote devices.

Meanwhile, the list of available services can be presented to users of local devices. In one implementation, this list can be presented through an interface such as a display screen. Users may select one of the available services, but if a service is not selected, the list of available services can be updated (306).

In responding to the selection (308) of an available service, the local device can connect (310) through the PAN to a remote device that can provide the selected service. In the case of Bluetooth-compliant PANs, if pairing has been established, the local device can connect with an accessory device. If the local device is not yet paired with the accessory device, pairing can be initiated when responding to service selection, and then the service (312) can be used through the PAN.

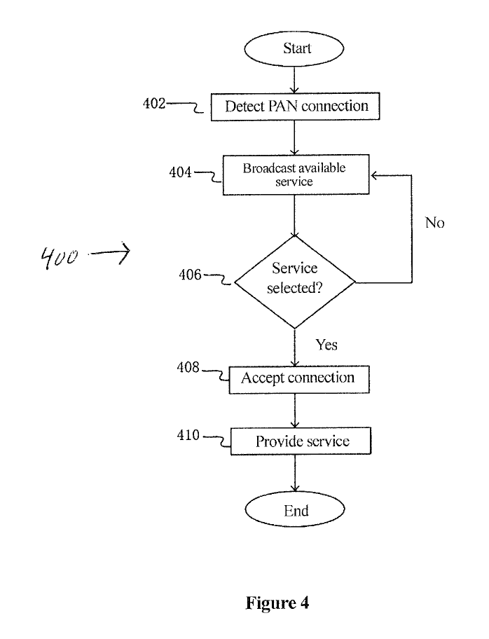

FIG. 4 is a flowchart of one non-limiting implementation of a connection service 400 that defines a technique for remote device service discovery in a PAN. The example is based on using the necessary public protocols, standards, and/or formats. The devices (one or more) being operated can be configured for communication through a Bluetooth-compliant PAN. When the transceiver of a local device is enabled and detects signals meeting the relevant protocol (402), the device can verify that a PAN is available. The available service (404) being broadcast is executed by the device in the PAN that is broadcasting it to be available. In responding to the selection (406) of an available service, the local device selecting the service can try to connect through the PAN with the remote device providing the service. The remote device can receive the connection (408), and then the service can be provided (410) through the PAN.

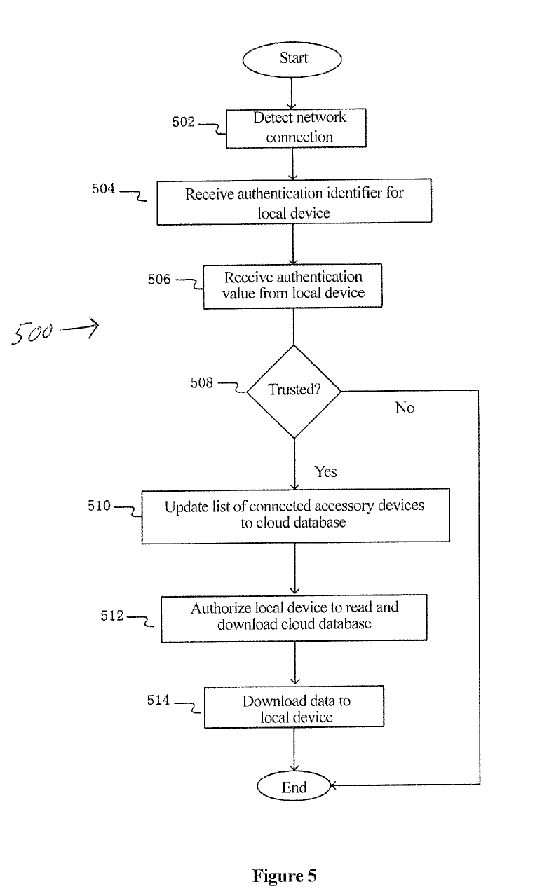

FIG. 5 is a flowchart of one non-limiting implementation of a connection service 500 that defines a data transfer between a cloud server and a local device on the Internet the process is executed by the local device, which can be handheld or portable. Process (500) begins with the local device detecting a network connection (502) and identifying itself to the server (504), and the server receiving an authentication value (506) from the local device. At this point, the cloud server has executed the authentication process, with the local device providing an authentication and the server determining whether the local device is trusted, based on the authentication value and device identifier. If adjudication (508) determines that the local device has been confirmed trustworthy, the list of accessory devices obtained by the local device through the 300 and 400 connection services is updated (510) to the cloud database; this will help the cloud database to analyze and keep a tally of whether these accessory devices are available. Finally, the local device is authorized (512) to read and download the cloud database, and then it executes the download to the local device (514).

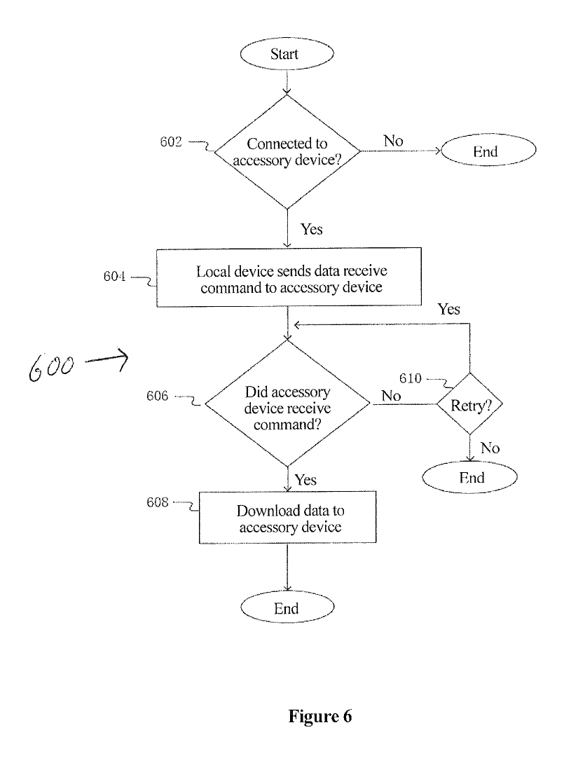

FIG. 6 is a flowchart of one non-limiting implementation of a remote device in a PAN downloading data from a local device. Downloading process 600 begins with a connection (602) between the local device and accessory device. After the connection is established, the local device gives the accessory device a command to receive data (604). If it is determined (606) that the accessory device received the command, the data is downloaded (608) to the accessory device. However, if it is determined that the accessory device did not receive the command—for example, if the accessory device was without power or beyond the range of the PAN—there is a determination (610) of whether to retry. If it is decided to retry, 604 is executed again (i.e., the local device re-issues the command for the accessory device to receive data), but otherwise the download process concludes.

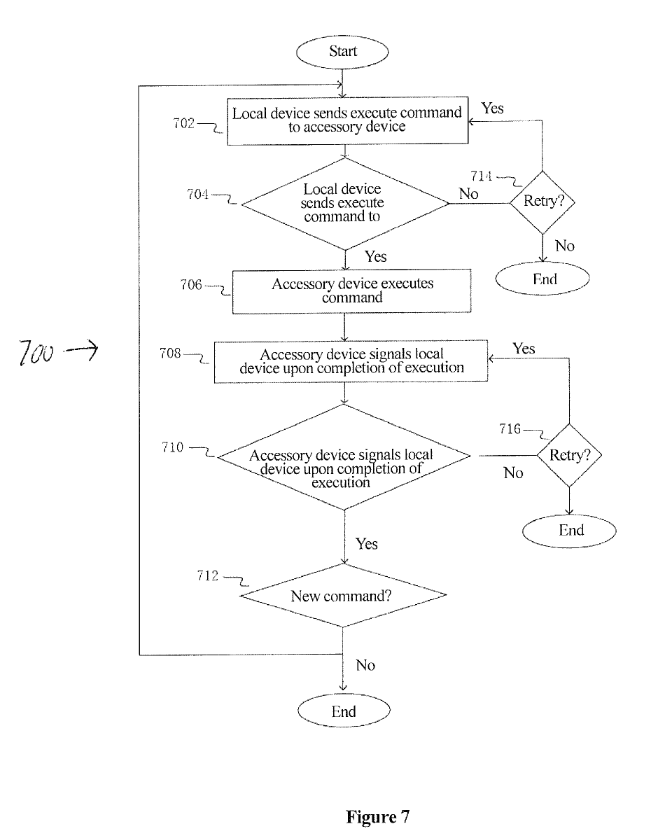

FIG. 7 is a flowchart of one implementation of data requests between a handheld or portable electronic device and an accessory device in a PAN. This interactive process (700) begins when the handheld or portable electronic device (local device) gives the accessory device a command to execute (702). If the accessory device receives the command (704), it is executed (706). After the command has finished executing, the accessory device signals (708) the handheld or portable electronic device accordingly. If the handheld or portable electronic device receives the signal indicating that the command has finished executing (710), it determines whether there is a new command. If there is a new command, 702 is re-executed (i.e., the new command is issued to the accessory device), but otherwise process 700 concludes. If the accessory device in process 704 does not receive the command—for example, if it was without power or beyond the range of the PAN—there is a determination (714) of whether to retry. If it is decided to retry, 702 is re-executed (i.e., the handheld or portable device re-issues the command), but otherwise process 700 concludes. As above, if the handheld or portable electronic device involved in the adjudication process (710) does not receive the signal that the command was completed—if it was without power or beyond the range of the PAN—there is a determination (716) of whether to try again. If it is decided to try again, 708 is re-executed (i.e., the accessory device signals once more that it has completed execution), but otherwise process 700 concludes.

The present system and method can be used in many and varied circumstances. Non-limiting examples include the following:
The accessory devices can be stuffed animal toys with the ability to produce speech sounds and potentially the ability to move.
A device such as an iPad can be used as the local device.
The cloud server can store and download to the iPad a series of “interactions” between the toys, for example to act out a predetermined scene. One example may be a passage from a children's book or fairy tale. For example, there could be an interaction between Winnie the Pooh and Tiger, of a type that is entertaining and/or instructive to a child. Multiple toys can be used to create more complex interactive scenarios.
A single toy can be used. One example is that a stuffed animal could tell a story or “read” a book to a child.
The toys speech/actions can be fully or partially predetermined and stored in the cloud server.

If it is partial, then the user (e.g., a subscriber to a web service) can add his or her own dialogue, potentially in his or her own voice. This way a parent can customize a story for the parent's child, or one or more people can create and put on a play using toys as the “actors.”
The user can entirely create unique content. For example a parent could record a message or lesson for a child, which is then delivered by the child's favorite toy.

It can be seen from the above written descriptions that after adopting this invention, it may be possible to bring about interaction, including dialogues, gestures, and actions, between a user and one or more objects, or between two or more objects. In addition, the invention has data extension, persona establishment, and background management, and can be extended to background control functions and effectively used in various kinds of intelligent toys.

Although features of the invention are shown in some drawings and not others, this is not a limitation of the invention. The invention is defined by the following claims, and other claims that may be made.

1. An interactive control method, comprising:
providing a client program on a handheld or portable electronic device employing a wireless mode to obtain data from a cloud server;
establishing a wireless data connection between the handheld or portable electronic device and an accessory device;
using the wireless connection to establish direct communication between the handheld or portable electronic device and the accessory device; and then
using the wireless connection for the handheld or portable electronic device to then transfer data previously obtained from the cloud server to the accessory device.

2. The interactive control method of claim 1 wherein using the wireless connection to establish direct communication between the handheld or portable electronic device and the accessory device comprises the accessory device sending a connect command to the handheld or portable electronic device and in response the handheld or portable electronic device sending a receive command to the accessory device.

3. The interactive control method of claim 1 wherein using the wireless connection to establish direct communication between the handheld or portable electronic device and the accessory device comprises the handheld or portable electronic device issuing a launch command to the accessory device, and then the accessory device issuing a receive command.

4. The interactive control method of claim 1 wherein the wireless data connection between the handheld or portable electronic device and the accessory device comprises near-field communications comprising either sound waves or Bluetooth.

5. The interactive control method of claim 1 wherein the data is stored in a cloud database.

6. The interactive control method of claim 5 wherein the data in the database is used to determine a template for content suitable for exchange between the accessory device and the user, or between one accessory device and another.

7. The interactive control method of claim 6 wherein the template is added to or modified through the cloud server and pushed to client software on the handheld or portable electronic device, and wherein the client software updates the data before it is downloaded to an accessory device.

8. The interactive control method of claim 1 wherein the accessory device comprises a smart toy and the data transferred to the accessory device results in operations by the accessory device that include at least one of dialogue, gestures, actions, and media playback.

9. The interactive control method of claim 1 wherein the accessory device comprises a device body with an embedded chip that connects with a user input device, a display, a network/bus interface, a power supply unit, solid state memory, RAM, and a loudspeaker.

10. The interactive control method of claim 9 wherein the accessory device user input device comprise at least one of buttons, a keyboard, or a wheel.

11. The interactive control method of claim 9 wherein the accessory device further includes a decoder (CODEC) between the loudspeaker and the embedded chip.

12. The interactive control method of claim 9 wherein the accessory device power supply unit includes a battery connected with the embedded chip through a charging module.

13. The interactive control method of claim 9 wherein the accessory device display is either a light-emitting diode (LED) display device or liquid crystal display (LCD) device.

14. An interactive control method, comprising:
providing a client program on a handheld or portable electronic device employing a wireless mode to obtain data stored in a cloud database;
establishing a wireless data connection between the handheld or portable electronic device and an accessory device, wherein the wireless data connection between the handheld or portable electronic device and the accessory device comprises near-field communications comprising either sound waves or Bluetooth and wherein the accessory device comprises a smart toy with a device body with an embedded chip that connects with a user input device, a display, a network/bus interface, a power supply unit, solid state memory, RAM, and a loudspeaker;
using the wireless connection to establish direct communication between the handheld or portable electronic device and the accessory device; and then
using the wireless connection for the handheld or portable electronic device to then transfer data previously obtained from the cloud server to the accessory device, wherein the data in the database is used to determine a template for content suitable for exchange between the accessory device and the user, or between one accessory device and another, and wherein the data transferred to the accessory device results in operations by the accessory device that include at least one of dialogue, gestures, actions, and media playback.

15. The interactive control method of claim 14 wherein the template is added to or modified through the cloud server and pushed to client software on the handheld or portable electronic device, and wherein the client software updates the data before it is downloaded to an accessory device.

16. The interactive control method of claim 15 wherein the accessory device user input device comprise at least one of buttons, a keyboard, or a wheel.

17. The interactive control method of claim 16 wherein the accessory device further includes a decoder (CODEC) between the loudspeaker and the embedded chip.

18. The interactive control method of claim 17 wherein the accessory device power supply unit includes a battery connected with the embedded chip through a charging module.

19. The interactive control method of claim 18 wherein the accessory device display is either a light-emitting diode (LED) display device or liquid crystal display (LCD) device.
